(19) United States
(12) Patent Application Publication
(10) Pub. No.: US 2026/0331507 A1
(43) Pub. Date: Oct. 22, 2026

(54) METHOD FOR PREPARING NEGATIVE ELECTRODE SLURRY AND A NEGATIVE ELECTRODE INCLUDING THE SAME

(71) Applicants: HYUNDAI MOTOR COMPANY, Seoul (KR); KIA CORPORATION, Seoul (KR); HANSOL CHEMICAL CO., LTD, Seoul (KR)

(72) Inventors: Taerim Lee, Hwaseong-si (KR); Yongho Lee, Hwaseong-si (KR); Chan Su Park, Iksan-si (KR); Gyun Tea Kim, Iksan-si (KR); Eun Song Lee, Iksan-si (KR); Chang Beom Kim, Iksan-si (KR); Se Man Kwon, Iksan-si (KR); Ji Hye Park, Iksan-si (KR)

(73) Assignees: HYUNDAI MOTOR COMPANY, Seoul (KR); KIA CORPORATION, Seoul (KR); HANSOL CHEMICAL CO., LTD, Seoul (KR)

(21) Appl. No.: 19/262,495

(22) Filed: Jul. 8, 2025

(30) Foreign Application Priority Data
Apr. 17, 2025 (KR) 10-2025-0050255

(51) Int. Cl. H01M 4/62; H01M 4/133; H01M 4/587

(52) U.S. Cl. CPC H01M 4/622; H01M 4/133; H01M 4/587; H01M 4/625

(57) ABSTRACT

A method for preparing a negative electrode slurry and a negative electrode including the same are disclosed. According to the method for preparing the negative electrode slurry, a relatively low negative electrode slurry viscosity may be secured under the same negative electrode slurry solid content conditions, dispersibility of the negative electrode slurry may be improved, and a binder delamination phenomenon may be improved. Additionally, due to improvement in electrode adhesion and negative electrode slurry dispersibility, a capacity retention rate of battery cells may be improved.

### CROSS-REFERENCE TO RELATED APPLICATION

This present application claims the benefit of and priority to Korean Patent Application No. 10-2025-0050255, filed on Apr. 17, 2025, in the Korean Intellectual Property Office, the entire contents of which are incorporated herein by reference.

### TECHNICAL FIELD

The present disclosure relates to a method for preparing a negative electrode slurry and a negative electrode including the same.

### BACKGROUND

In battery research, the development of silicon-graphite composite electrodes utilizing silicon (Si)-based negative electrode materials is actively progressing to balance physical properties and electrochemical performance. Silicon possesses a high theoretical capacity, which is advantageous for increasing energy density. However, it may undergo volume changes of more than 300% during charging and discharging processes. This leads to disruption of the electron conduction network within the electrode, formation of a thick solid electrolyte interface (SEI), and degradation of electrode performance, acting as a major cause of weakening battery cycle life stability.

To address these issues, research introducing polyacrylic acid-polyvinyl alcohol (PAA-PVA) based binders instead of carboxymethyl cellulose (CMC), which is typically widely used as a negative electrode binder, is gaining attention. PAA-PVA can serve as a buffer for silicon's volume changes, reducing negative electrode expansion rates compared to CMC and improving long-term durability. In particular, PAA-PVA binders are expected to play an important role in securing cycle life stability of silicon-graphite composite electrodes.

However, when PAA-PVA binders are applied to existing negative electrode slurry preparation methods, the slurry viscosity increases, and the dispersibility among active materials, conductive materials, and binders decreases, making it difficult to manufacture uniform electrodes. Additionally, when additional solvents are introduced due to viscosity increase issues, this may not only reduce the electrode coating speed but also potentially cause binder delamination. These are major obstacles hindering the practical commercialization of PAA-PVA.

Therefore, the development of a new negative electrode slurry preparation process is essential for utilizing PAA-PVA as a binder for silicon-graphite composite electrodes.

The matters described in this Background section are only for enhancement of understanding of the background of the present disclosure and should not be taken as acknowledgement that they correspond to prior art already known to those having ordinary skill in the art.

### SUMMARY

The following summary presents a simplified summary of certain features. The summary is not an extensive overview and is not intended to identify key or critical elements.

The present disclosure is directed to providing a method for preparing a negative electrode slurry capable of securing a relatively low slurry viscosity under the same solid content conditions.

Furthermore, the present disclosure is directed to providing a method for preparing a negative electrode slurry that can be applied to green technology fields such as electric vehicle batteries.

According to an aspect of the present disclosure, a method for preparing a negative electrode slurry includes kneading a first slurry comprising a negative electrode active material, a portion of a first binder, and a first solvent. The method further includes preparing a second slurry comprising the first slurry and a second solvent. The method further includes preparing a third slurry comprising at least one of the second slurry, a remaining portion of the first binder, a third solvent, or a first conductive material. The method further includes preparing a fourth slurry comprising the third slurry and a second binder. The method further includes preparing a fifth slurry including the fourth slurry and a fourth solvent.

The negative electrode active material according to one embodiment may include a silicon-based negative electrode active material and a carbon-based negative electrode active material.

The silicon-based negative electrode active material according to one embodiment may include at least one of SiOx, Si, Si—C composite, or metal silicide.

The carbon-based negative electrode active material according to one embodiment may include at least one of artificial graphite, natural graphite, or hard carbon.

The first binder according to one embodiment may include a copolymer prepared by copolymerizing and hydrolyzing acrylate series monomers and vinyl acetate series monomers.

The copolymer according to one embodiment may be prepared by copolymerizing and hydrolyzing 65 mol % to 99 mol % of the acrylate series monomers and 1 mol % to 35 mol % of the vinyl acetate series monomers.

The first solvent, the second solvent, the third solvent, and the fourth solvent according to one embodiment may each independently include at least one of water, pure water, deionized water, distilled water, ethanol, isopropanol, methanol, acetone, n-propanol, or t-butanol.

A weight ratio of the portion of the first binder to the remaining portion of the first binder according to one embodiment may be 100:10 to 50.

The first conductive material according to one embodiment of the present disclosure may include at least one of single-walled carbon nanotubes (SWCNT), double-walled carbon nanotubes (DWCNT), multi-walled carbon nanotubes (MWCNT), carbon black, graphene, or carbon fiber.

The second binder according to one embodiment may include at least one of styrene-butadiene rubber, acrylated styrene-butadiene rubber, acrylonitrile-butadiene rubber, or acrylic rubber.

A volume ratio of the first solvent to the fourth solvent according to one embodiment of the present disclosure may be 1:50 to 100.

The preparing the fifth slurry according to one embodiment may be performed by adding the fourth solvent to the fourth slurry in a single addition.

The method for preparing a negative electrode slurry according to one embodiment may further include, before the kneading the first slurry, dry mixing the negative electrode active material and a second conductive material.

According to another aspect of the present disclosure, a negative electrode for a secondary battery includes a negative electrode current collector and a negative electrode active material layer formed by coating the negative electrode slurry prepared by the above method on at least one surface of the negative electrode current collector.

According to still another aspect of the present disclosure, a negative electrode slurry includes a negative electrode active material; a first binder; a second binder; a conductive material; and a solvent. The first binder includes a copolymer of acrylate series monomers and vinyl acetate series monomers. The second binder includes at least one of styrene-butadiene rubber, acrylated styrene-butadiene rubber, acrylonitrile-butadiene rubber, or acrylic rubber.

The conductive material according to one embodiment may include at least one of single-walled carbon nanotubes (SWCNT), double-walled carbon nanotubes (DWCNT), multi-walled carbon nanotubes (MWCNT), carbon black, graphene, or carbon fiber.

The solvent according to one embodiment may include at least one of water, pure water, deionized water, distilled water, ethanol, isopropanol, methanol, acetone, n-propanol, or t-butanol.

The negative electrode slurry according to one embodiment may have a solid content of 30 to 70% and a viscosity of 3500 to 8500 cP.

According to one aspect of the present disclosure, a relatively low negative electrode slurry viscosity may be secured under the same negative electrode slurry solid content conditions.

According to another aspect of the present disclosure, the dispersibility of the negative electrode slurry may be improved.

According to still another aspect of the present disclosure, a binder delamination phenomenon may be improved.

According to yet another aspect of the present disclosure, due to improvement in electrode adhesion and negative electrode slurry dispersibility, the capacity retention rate of battery cells may be improved.

Effects of the present disclosure are not limited to the above-mentioned effects, and other effects, not mentioned above, should be clearly understood by those having ordinary skill in the art from the present disclosure.

### BRIEF DESCRIPTION OF THE DRAWINGS

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a flowchart illustrating a method for preparing a negative electrode slurry according to one embodiment of the present disclosure.

FIG. 2 illustrates photographs showing shortcomings of a negative electrode slurry comprising polyacrylic acid-polyvinyl alcohol (PAA-PVA) binder manufactured according to an existing method.

FIG. 3 is a graph confirming flow characteristics by examining the behavior of viscosity according to shear rate of the negative electrode slurry prepared according to examples and comparative examples of the present disclosure.

FIG. 4 is an image of a negative electrode composite layer formed on a Cu foil.

FIG. 5 shows the results of measuring interlayer interfacial adhesion of a negative electrode composite layer manufactured using the negative electrode slurry prepared according to examples and comparative examples of the present disclosure.

### DETAILED DESCRIPTION

Hereinafter, the present disclosure is described in more detail. However, the following embodiments are provided merely as references for describing the present disclosure in detail, and the present disclosure is not limited thereto and may be implemented in various forms

Unless otherwise defined, all technical and scientific terms used herein have the same meaning as commonly understood by those having ordinary skill in the art to which the present disclosure pertains.

The terms used herein are intended merely to describe particular embodiments effectively and are not intended to limit the present disclosure.

Singular forms “a,” “an,” and “the” used in the present disclosure and the appended claims are intended to include plural referents unless the context clearly dictates otherwise.

The units used in the present disclosure, unless otherwise stated, are based on weight. For instance, the units such as “%” or “ratio” refer to weight percent (wt. %) or weight ratio, respectively. Unless otherwise defined, weight percent (wt. %) refers to the proportion of a specific component within the total composition, expressed as a percentage by weight.

When a portion is described as “including” or “comprising” a certain component, it means that, unless specifically stated to the contrary, the inclusion of other components is not excluded but rather that additional components may also be included.

In addition, numerical ranges used in the present disclosure may include all values between the lower and upper limits, all values incrementally derived logically within shape and breadth of the defined ranges, all double-limited values, and all possible combinations of upper and lower limits of differently limited numerical ranges. Unless specifically defined in the specification of the present disclosure, values outside the defined numerical ranges that may occur due to experimental error or rounding off of values are also included within the defined numerical ranges.

The term “portion” used herein may mean a specific part or small range of the total amount or total volume of a specific material used in the preparation of the negative electrode slurry, and even if the expression “portion” is commonly used in the respective steps of the process, the amount or volume indicated thereby may be independent. Also, the term “remaining portion” used herein may mean the remainder of the total amount or total volume of a specific material used in the preparation of the negative electrode slurry, excluding the “portion.”

An aspect of the present disclosure may provide a method for preparing a negative electrode slurry. The method comprises kneading a first slurry including a negative electrode active material, a portion of a first binder, and a first solvent. The method further comprises preparing a second slurry including the first slurry and a second solvent. The method further comprises preparing a third slurry including at least one of the second slurry, the remaining portion of the first binder, a third solvent, or a first conductive material. The method further comprises preparing a fourth slurry including the third slurry and a second binder. The method further comprises preparing a fifth slurry including the fourth slurry and a fourth solvent. When negative electrode slurry is prepared according to existing methods, the viscosity of the negative electrode slurry is high, which may result in in poor processability, and dispersion of negative electrode active material, conductive material, binder, and the like in the negative electrode slurry is not sufficiently achieved, which may cause defects such as binder agglomeration as shown in FIG. 2 when coated on the current collector. The method for preparing negative electrode slurry of the present disclosure may improve these shortcomings.

The following provides a more detailed description of the present disclosure.

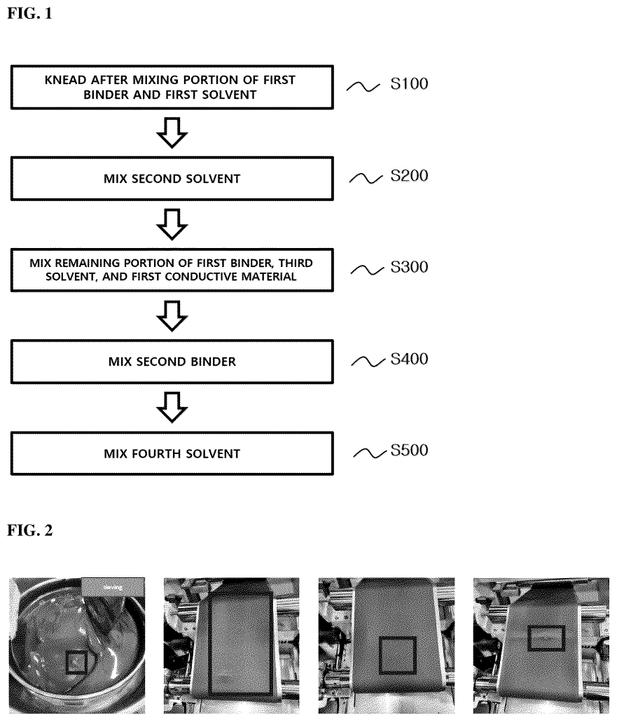

Referring to FIG. 1, kneading (S100) may include kneading a first slurry after preparing the first slurry by mixing a negative electrode active material, a portion of a first binder, and a first solvent.

In one embodiment, the kneading may be performed at a shear force of 60 Pa or more, specifically 100 to 150 Pa and may be performed for 10 to 90 minutes, specifically 20 to 60 minutes, more specifically 20 to 40 minutes. When this range is satisfied, the negative electrode active material may be uniformly dispersed in the first slurry.

In one embodiment, the negative electrode active material may include a silicon-based negative electrode active material and a carbon-based negative electrode active material.

In one embodiment, the silicon-based negative electrode active material may include at least one of SiOx, Si, Si—C composite, or metal silicide, but is not limited thereto as long as the objectives of the present disclosure can be achieved.

In one embodiment, the carbon-based negative electrode active material may include at least one of artificial graphite, natural graphite, or hard carbon, but is not limited thereto as long as the objectives of the present disclosure can be achieved.

In one embodiment, the first binder may include a copolymer of acrylate series monomers and vinyl acetate series monomers.

In one embodiment, the copolymer may be prepared by copolymerizing and hydrolyzing the acrylate series monomers and vinyl acetate series monomers.

In one embodiment of the present disclosure, the hydrolysis may be alkaline hydrolysis.

In one embodiment, the copolymer may be prepared by copolymerizing and hydrolyzing 65 mol % to 99 mol % of the acrylate series monomers and 1 mol % to 35 mol % of the vinyl acetate series monomers.

In one embodiment, the copolymer may include, based on 100 mol % of the total copolymer weight, 65 mol % to 99 mol % of acrylate series monomer units and acrylic acid series monomer units, and 1 mol % to 35 mol % of vinyl acetate series monomer units and vinyl alcohol series monomer units.

In one embodiment, the acrylic acid series monomer units and vinyl alcohol series monomer units may exceed 0 weight %.

For example, the copolymer may include, based on 100 mol % of the total copolymer weight, 0 mol % to 5 mol % of acrylate series monomer units and 0 mol % to 5 mol % of vinyl acetate series monomer units.

In other words, the acrylate series monomers and the vinyl acetate series monomers may each be copolymerized to form the acrylate series monomer units and the vinyl acetate series monomer units, respectively.

In one embodiment, the acrylate series monomer units may be formed by polymerizing one or more selected from the group consisting of methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, sec-butyl acrylate, sec-butyl methacrylate, tert-butyl acrylate, tert-butyl methacrylate, ethyl hexyl acrylate, ethyl hexyl methacrylate, lauryl acrylate, lauryl methacrylate, stearyl acrylate, and stearyl methacrylate.

In one embodiment, the vinyl acetate series monomer units may be formed by polymerizing one or more selected from the group consisting of vinyl acetate, vinyl alcohol, ethylene vinyl acetate, and vinyl acetals.

In one embodiment, by hydrolysis, a portion of the vinyl acetate series monomer units may be converted to vinyl alcohol series monomer units.

In one embodiment, by hydrolysis, a portion of the acrylate series monomer units may be converted to acrylic acid series monomer units.

In one embodiment, the degree of hydrolysis may be controlled to, for example, 70% or more, 75% or more, 80% or more, 85% or more, 90% or more, or 95% or more.

This means, for example, 70% or more, 75% or more, 80% or more, 85% or more, 90% or more, or 95% or more of the vinyl acetate series monomer units may be converted to vinyl alcohol series monomer units.

In addition, for example, 70% or more, 75% or more, 80% or more, 85% or more, 90% or more, or 95% or more of the acrylate series monomer units may be converted to acrylic acid series monomer units.

If the acrylate series monomer units exceed or fall below the content range of the present disclosure, it may cause decreased binding strength.

If the acrylic acid series monomer units exceed or fall below the content range of the present disclosure, it may cause polymer aggregation and precipitation or decreased adhesion.

If the vinyl acetate monomer units exceed or fall below the content range of the present disclosure, it may cause stability issues such as storage stability.

If the vinyl alcohol series monomer units exceed or fall below the content range of the present disclosure, it may cause decreased adhesion, increased viscosity, and increased particle size.

In one embodiment, the acrylic acid series monomer units may be combined with an alkali metal.

In other words, the carboxylate groups of the acrylic acid series monomer units may be combined with an alkali metal.

In one embodiment, the weight ratio of the alkali metal to the copolymer (weight of the alkali metal: weight of the copolymer) may be 0.8 to 6.5:100.

If the weight ratio of the alkali metal to the copolymer exceeds or falls below the weight ratio of the present disclosure, the binding characteristics of the first binder may be deteriorated.

The binding strength of the first binder comprising the alkali metal may be determined by the strength of cohesion and repulsion forces between elements, and the adhesion may change due to changes in the relative strength of cohesion, adhesion, and repulsion forces as the alkali metal content varies.

The binding strength of the first binder may improve the lifespan characteristics of the secondary battery.

In one embodiment, the number-average molecular weight of the copolymer may be 250,000 to 350,000.

In one embodiment, the solid content of the first slurry may be 75 to 85%, specifically 77 to 80%. When this range is satisfied, the first binder may sufficiently coat the negative electrode active material, thereby improving the electrochemical performance of the negative electrode.

Preparing a second slurry (S200) may include preparing a second slurry by mixing the first slurry and a second solvent. Through the preparing the second slurry, the dispersibility of the negative electrode active material coated with the first binder included in the first slurry may be improved.

In one embodiment, the solid content of the second slurry may be 60 to 75%, specifically 65 to 73%. When this range is satisfied, the dispersibility of the negative electrode active material may be improved.

Preparing a third slurry (S300) may include preparing a third slurry by mixing two or more selected from the group consisting of the second slurry, the remaining portion of the first binder, a third solvent, and a first conductive material.

In one embodiment, in the preparing the third slurry, the mixing may be performed in one step or in multiple sequential steps. Specifically, the mixing may be performed either by mixing the second slurry, the remaining portion of the first binder, and the first conductive material in a single mixing, or by first dividing the remaining portion of the first binder into two parts, then mixing one part with the second slurry and the third solvent, and subsequently adding the other part and the first conductive material.

In one embodiment, the first conductive material may include at least one selected from the group consisting of single-walled carbon nanotubes (SWCNT), double-walled carbon nanotubes (DWCNT), and multi-walled carbon nanotubes (MWCNT).

In one embodiment, the solid content of the third slurry may be 55 to 70%, specifically 60 to 68%. When this range is satisfied, the dispersibility of the negative electrode active material may be improved.

In one embodiment, the weight ratio of the portion of the first binder to the remaining portion of the first binder may be 100:10 to 50, specifically 100:20 to 30. When satisfying this range, dispersion of the first binder may be efficiently achieved.

Preparing a fourth slurry (S400) may include preparing a fourth slurry by mixing the third slurry and a second binder.

In one embodiment, the second binder may include at least one selected from the group consisting of styrene-butadiene rubber, acrylated styrene-butadiene rubber, acrylonitrile-butadiene rubber, and acrylic rubber.

The addition of the second binder may improve electrode adhesion.

In one embodiment, the weight ratio of the first binder to the second binder may be 100:1 to 20, specifically 100:5 to 10. However, the weight ratio is not limited thereto as long as the objectives of the present disclosure can be achieved. Meanwhile, the weight of the first binder refers to the sum of the weight of the portion of the first binder and the weight of the remaining portion of the first binder.

Preparing a fifth slurry (S500) may include preparing a fifth slurry by mixing the fourth slurry and a fourth solvent.

In one embodiment, in the preparing a fifth slurry, the mixing may be performed by adding the fourth solvent to the fourth slurry in a single addition. When this is satisfied, the viscosity of the negative electrode slurry may be lowered, and the dispersibility of the negative electrode slurry and the adhesion of the electrode may be improved.

In one embodiment, the volume ratio of the first solvent to the fourth solvent may be 1:50 to 100, specifically 1:60 to 90, more specifically 1:70 to 80. When this volume ratio is satisfied, a relatively low viscosity can be secured at the same solid content compared to other volume ratios, thereby improving the dispersibility of the slurry and preventing binder delamination.

In one embodiment, the first solvent, the second solvent, the third solvent, and the fourth solvent may each independently include at least one selected from the group consisting of water, pure water, deionized water, distilled water, ethanol, isopropanol, methanol, acetone, n-propanol, and t-butanol.

According to one embodiment of the present disclosure, the mixing performed in each step of the method for preparing the negative electrode slurry may each independently be performed by one or more methods of ball milling, mechanofusion milling, shaker milling, planetary milling, attritor milling, shape milling, nauta milling, Nobilta milling, high speed mixing, paddle mixing, ribbon mixing, Henschel mixing, cone-type mixing, Thinky mixing, homogenizing mixing, agitator mixing, or a combination thereof.

In one embodiment, the method for preparing a negative electrode slurry may further include, before the kneading the first slurry, dry mixing the negative electrode active material and a second conductive material. By further including the dry mixing, the electrical connectivity of the negative electrode active material may be increased, and the mixing efficiency may be improved when subsequently making the slurry by adding binder and solvent.

In one embodiment, the second conductive material may include at least one selected from the group consisting of single-walled carbon nanotubes (SWCNT), double-walled carbon nanotubes (DWCNT), multi-walled carbon nanotubes (MWCNT), carbon black, graphene, and carbon fiber.

In one embodiment, the negative electrode active material and the second conductive material may be dry mixed in a weight ratio of 100:0.1 to 5, specifically 100:0.5 to 3, more specifically 100:0.8 to 1.5, but it is not limited thereto as long as the objectives of the present disclosure can be achieved.

Furthermore, the present disclosure may provide a negative electrode for a secondary battery, comprising a negative electrode current collector, and a negative electrode active material layer formed by coating the negative electrode slurry prepared by the above method on at least one surface of the negative electrode current collector.

Furthermore, the present disclosure may provide a negative electrode slurry comprising a negative electrode active material, a first binder, a second binder, a conductive material, and a solvent. The first binder includes a copolymer of acrylate series monomers and vinyl acetate series monomers. The second binder includes at least one selected from the group consisting of styrene-butadiene rubber, acrylated styrene-butadiene rubber, acrylonitrile-butadiene rubber, and acrylic rubber.

In one embodiment, the conductive material may include at least one selected from the group consisting of single-walled carbon nanotubes (SWCNT), double-walled carbon nanotubes (DWCNT), and multi-walled carbon nanotubes (MWCNT).

In one embodiment, the solvent may include at least one selected from the group consisting of water, pure water, deionized water, distilled water, ethanol, isopropanol, methanol, acetone, n-propanol, and t-butanol.

In one embodiment, the negative electrode slurry may have a solid content of 30 to 70% and a viscosity of 3500 to 8500 cP.

In one embodiment, when the negative electrode slurry has a solid content of 30 to 40%, the viscosity may be 3500 to 5500 cP, specifically 4000 to 5000 cP. When the solid content is 40 to 50%, the viscosity may be 4500 to 6500 cP, specifically 5000 to 6000 cP. When the solid content is 50 to 60%, the viscosity may be 5500 to 7500 cP, specifically 6000 to 7000 cP. When the solid content is 60 to 70%, the viscosity may be 6500 to 8500 cP, specifically 7000 to 8000 cP.

Hereinafter, various examples and comparative examples of the present disclosure are described. However, the following examples are merely illustrative of the present disclosure, and the present disclosure is not limited to these examples.

### Example 1

12.24 g of negative electrode active material powder and 0.128 g of Super C powder were dry mixed to obtain a mixed powder.

12.368 g of the mixed powder, 3.68 g of polyacrylic acid-polyvinyl alcohol (PAA-PVA) copolymer (Hansol Chemical, HS-100), and distilled water were added and kneaded for 30 minutes to obtain a first slurry. At this time, the solid content of the first slurry was 78%.

Distilled water was added to the first slurry to prepare a second slurry. At this time, the solid content of the second slurry was 70%.

0.92 g of PAA-PVA copolymer and 3.196 g of SWCNT (OCSiAl TUBALL BATT H2O 0.4%) solution were added to the second slurry and mixed for 20 minutes at 100 rpm to prepare a third slurry.

0.383 g of SBR was added to the third slurry and mixed to prepare a fourth slurry.

7.8 ml of distilled water was added all at once to the fourth slurry and mixed to prepare a negative electrode slurry with a final solid content of 45%.

### Example 2

Except for adding 2.76 g of PAA-PVA copolymer when preparing the first slurry and adding 1.84 g of PAA-PVA copolymer when preparing the third slurry, Example 2 was conducted in the same manner as Example 1.

### Example 3

Except for adding 0.92 g of PAA-PVA copolymer and distilled water to the second slurry of Example 1 and mixing to make the solid content 62.5%, then additionally adding 0.92 g of PAA-PVA copolymer and 3.196 g of SWCNT (OCSiAl TUBALL BATT H2O 0.4%) solution and mixing for 20 minutes at 100 rpm to prepare a third slurry, Example 3 was conducted in the same manner as Example 1.

### Comparative Example 1

Except for adding 2.6 ml of distilled water to the fourth slurry of Example 1 and mixing, then repeating this process three times, Comparative Example 1 was conducted in the same manner as Example 1.

### Comparative Example 2

12.24 g of negative electrode active material powder and 0.128 g of Super C powder were dry mixed to obtain a mixed powder.

12.368 g of the mixed powder and 4.6 g of PAA-PVA copolymer (Hansol Chemical, HS-100) were mixed to prepare a mixture.

3.196 g of SWCNT (OCSiAl TUBALL BATT H2O 0.4%) solution and distilled water were added to the mixture and mixed for 20 minutes at 100 rpm to prepare a first slurry. At this time, the solid content of the first slurry was 78%.

Distilled water was added to the first slurry and mixed to prepare a second slurry. At this time, the solid content of the second slurry was 70%.

SBR was added to the second slurry and mixed to prepare a third slurry.

7.8 ml of distilled water was added all at once to the third slurry and mixed to prepare a negative electrode slurry with a final solid content of 45%.

### Comparative Example 3

Except for adding 2.6 ml of distilled water to the third slurry of Comparative Example 2 and mixing, then repeating this process three times, Comparative Example 3 was conducted in the same manner as Comparative Example 2.

### Comparative Example 4

Except for not adding SBR, Comparative Example 4 was conducted in the same manner as Example 1.

### Comparative Example 5

Except for not adding SBR, Comparative Example 5 was conducted in the same manner as Comparative Example 3.

### Experimental Example 1: Slurry Viscosity Measurement

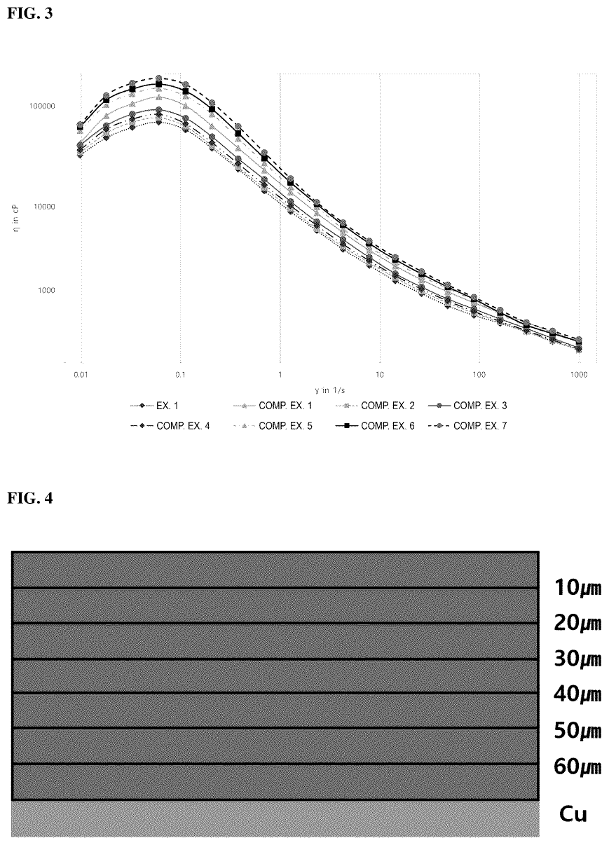

The viscosity of the negative electrode slurry prepared according to the examples and comparative examples of the present disclosure was measured. The viscosity was measured using a Brookfield viscometer and a rheometer, and the results are shown in Table 1 and FIG. 3.

TABLE 1

| | Slurry Solid | Slurry |
|---|---|---|
| | Content (%) | Viscosity (cP) |
| Example 1 | 45.0% | 4880 |
| Example 2 | 45.0% | 5120 |
| Example 3 | 45.0% | 5530 |
| Comparative Example 1 | 45.0% | 6550 |
| Comparative Example 2 | 45.0% | 5250 |
| Comparative Example 3 | 45.0% | 7220 |
| Comparative Example 4 | 45.0% | 7330 |
| Comparative Example 5 | 45.0% | 9950 |

As can be seen from Table 1 and FIG. 3, in the case of Example 1, it was confirmed that the slurry viscosity characteristics were lower and the slurry viscosity was improved in the overall shear rate region compared to Comparative Examples 1 to 3. This indicates that the method of adjusting the amount of solvent added during the negative electrode slurry preparation process and adding a large amount of solvent all at once was effective in lowering the slurry viscosity.

From the above experimental results, it can be seen that when using the negative electrode slurry preparation method of the present disclosure, a lower slurry viscosity is exhibited under the same slurry solid content conditions, which is advantageous for slurry transfer in terms of process. Also, because the slurry viscosity is low, the slurry solid content may be higher, which is advantageous for the drying process during electrode manufacturing.

### Experimental Example 2: Confirmation of Electrode Adhesion

### 2.1 Electrode Adhesion

The adhesion of the negative electrode was measured using a universal testing machine (UTM), and the results are shown in Table 2.

TABLE 2

| | Electrode |
|---|---|
| | Adhesion (gf/cm) |
| Example 1 | 11.5 |
| Example 2 | 10.8 |
| Example 3 | 11.0 |
| Comparative Example 1 | 10.2 |
| Comparative Example 2 | 9.2 |
| Comparative Example 3 | 8.4 |
| Comparative Example 4 | 6.0 |
| Comparative Example 5 | 4.5 |

As can be seen from Table 2, when comparing Example 1 with Comparative Examples 1 to 3, it was confirmed that when the kneading treatment and the method of adding a large amount of solvent all at once at the end of the process are used, the adhesion of the negative electrode was improved compared to when not using these methods.

Comparative Examples 4 and 5 had no additional binder addition such as SBR, resulting in relatively lower absolute adhesion compared to other examples. However, it was confirmed that even with such composition, the electrode adhesion could be improved

through kneading treatment.

2.2 Adhesion Gradient of the Composite Layer

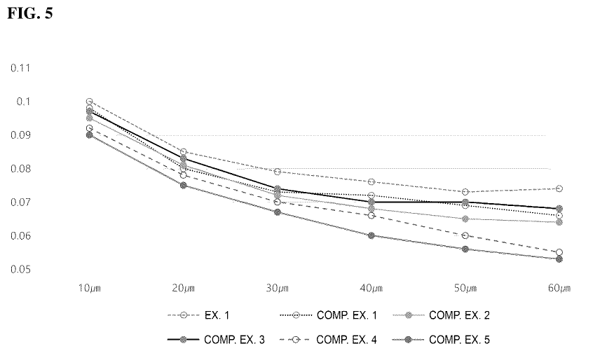

To evaluate the interfacial adhesion of each layer of the negative electrode composite layer, the sectional interfacial adhesion of the negative electrode composite layer manufactured as shown in FIG. 4 was measured using SAICAS, and the results are shown in Table 3 and FIG. 5.

TABLE 3

| | | | | | | | Adhesion |
|---|---|---|---|---|---|---|---|
| | | | | | | | Ratio at |
| | | | | | | | 60 μm |
| | | | | | | | Compared to |
| | Sectional Adhesion | | | | | | 10 μm |
| | 10 μm | 20 μm | 30 μm | 40 μm | 50 μm | 60 μm | (%) |
| Example 1 | 0.1 | 0.085 | 0.079 | 0.076 | 0.073 | 0.074 | 74 |
| Example 2 | 0.095 | 0.081 | 0.072 | 0.068 | 0.065 | 0.064 | 67 |
| Example 3 | 0.097 | 0.083 | 0.074 | 0.07 | 0.07 | 0.068 | 70 |
| Comparative | 0.098 | 0.08 | 0.073 | 0.072 | 0.069 | 0.066 | 67 |
| Example 1 | | | | | | | |
| Comparative | 0.092 | 0.078 | 0.07 | 0.066 | 0.06 | 0.055 | 60 |
| Example 2 | | | | | | | |
| Comparative | 0.09 | 0.075 | 0.067 | 0.06 | 0.056 | 0.053 | 59 |
| Example 3 | | | | | | | |

As can be seen from Table 3 and FIG. 5, the Examples and Comparative Example 1, which used kneading treatment with a portion of the binder, had a higher adhesion ratio at 60 μm compared to 10 μm than Comparative Examples 2 and 3, which did not use this treatment. This confirms that the dispersion of the binder in the negative electrode slurry was improved through the kneading treatment, which may improve the binder delamination phenomenon.

### Experimental Example 3: Capacity Retention Rate Evaluation

Coin full cells were manufactured using negative electrodes made with the negative electrode slurry prepared according to the examples and comparative examples of the present disclosure, and the capacity retention rate after 50 cycles compared to the first cycle was measured. The results are shown in Table 4.

TABLE 4

| | Capacity Retention |
|---|---|
| | Rate @50th Cycle (%) |
| Example 1 | 96.4% |
| Example 2 | 95.8% |
| Example 3 | 95.6% |
| Comparative Example 1 | 95.2% |
| Comparative Example 2 | 94.3% |
| Comparative Example 3 | 94.0% |

As can be seen from Table 4, Examples 1 to 3 all had higher capacity retention rates after 50 cycles compared to Comparative Examples 1 to 3. Therefore, it was confirmed that when using the negative electrode slurry preparation method of the present disclosure, electrode adhesion and slurry dispersibility may be improved, securing improved cycle life stability of the electrode.

The features, structures, effects, and the like described in the embodiments above are included in at least one embodiment of the present disclosure and are not necessarily limited to a single embodiment. Furthermore, the features, structures, effects, and the like exemplified in each embodiment can be combined or modified in other embodiments by those having ordinary skill in the art to which the embodiments pertain. Therefore, such combinations and modifications should be construed as being within the scope of the present disclosure.

What is claimed is:

1. A method for preparing a negative electrode slurry, the method comprising:
kneading a first slurry comprising a negative electrode active material, a portion of a first binder, and a first solvent;
preparing a second slurry comprising the first slurry and a second solvent;
preparing a third slurry comprising the second slurry and at least one of a remaining portion of the first binder, a third solvent, or a first conductive material;
preparing a fourth slurry comprising the third slurry and a second binder; and
preparing a fifth slurry comprising the fourth slurry and a fourth solvent.

2. The method of claim 1, wherein the negative electrode active material comprises a silicon-based negative electrode active material and a carbon-based negative electrode active material.

3. The method of claim 2, wherein the silicon-based negative electrode active material comprises at least one of SiOx, Si, Si—C composite, or metal silicide.

4. The method of claim 2, wherein the carbon-based negative electrode active material comprises at least one of artificial graphite, natural graphite, or hard carbon.

5. The method of claim 1, wherein the first binder comprises a copolymer prepared by copolymerizing and hydrolyzing acrylate series monomers and vinyl acetate series monomers.

6. The method of claim 5, wherein the copolymer is prepared by copolymerizing and hydrolyzing 65 mol % to 99 mol % of the acrylate series monomers and 1 mol % to 35 mol % of the vinyl acetate series monomers.

7. The method of claim 1, wherein the first solvent, the second solvent, the third solvent, and the fourth solvent each independently comprise at least one of water, pure water, deionized water, distilled water, ethanol, isopropanol, methanol, acetone, n-propanol, or t-butanol.

8. The method of claim 1, wherein a weight ratio of the portion of the first binder to the remaining portion of the first binder is 100:10 to 50.

9. The method of claim 1, wherein the first conductive material comprises at least one of single-walled carbon nanotubes (SWCNT), double-walled carbon nanotubes (DWCNT), multi-walled carbon nanotubes (MWCNT), carbon black, graphene, or carbon fiber.

10. The method of claim 1, wherein the second binder comprises at least one of styrene-butadiene rubber, acrylated styrene-butadiene rubber, acrylonitrile-butadiene rubber, or acrylic rubber.

11. The method of claim 1, wherein a volume ratio of the first solvent to the fourth solvent is 1:50 to 100.

12. The method of claim 1, wherein the preparing the fifth slurry is performed by adding the fourth solvent to the fourth slurry in a single addition.

13. The method of claim 1, further comprising, before the kneading the first slurry, dry mixing the negative electrode active material and a second conductive material.

14. A negative electrode for a secondary battery, the negative electrode comprising:
a negative electrode current collector; and
a negative electrode active material layer formed by coating the negative electrode slurry prepared by the method of claim 1 on at least one surface of the negative electrode current collector.

15. A negative electrode slurry comprising:
a negative electrode active material;
a first binder;
a second binder;
a conductive material; and
a solvent,
wherein the first binder comprises a copolymer of acrylate series monomers and vinyl acetate series monomers, and
wherein the second binder comprises at least one of styrene-butadiene rubber, acrylated styrene-butadiene rubber, acrylonitrile-butadiene rubber, or acrylic rubber.

16. The negative electrode slurry of claim 15, wherein the conductive material comprises at least one of single-walled carbon nanotubes (SWCNT), double-walled carbon nanotubes (DWCNT), multi-walled carbon nanotubes (MWCNT), carbon black, graphene, or carbon fiber.

17. The negative electrode slurry of claim 15, wherein the solvent comprises at least one of water, pure water, deionized water, distilled water, ethanol, isopropanol, methanol, acetone, n-propanol, or t-butanol.

18. The negative electrode slurry of claim 15, wherein the negative electrode slurry has a solid content of 30 to 70% and a viscosity of 3500 to 8500 cP.
